(19) United States
(12) Patent Application Publication
(10) Pub. No.: US 2024/0380151 A1
(43) Pub. Date: Nov. 14, 2024

(54) Connector Assembly

(71) Applicant: APPLE INC., Cupertino, CA (US)

(72) Inventors: Darshan R. Kasar, Redwood City, CA (US); Daniel C. Wagman, Scotts Valley, CA (US); Joshua A. Mendoza, Lancaster, CA (US); Muhammad F. Hossain, Sunnyvale, CA (US); James C. Wu, Menlo Park, CA (US); Christopher S. Graham, San Francisco, CA (US)

(21) Appl. No.: 18/690,100

(22) PCT Filed: Sep. 15, 2022
(86) PCT No.: PCT/US2022/043565

§ 371 Date: Mar. 7, 2024

Related U.S. Application Data
(60) Provisional application No. 63/244,886, filed on Sep. 16, 2021.

(51) Int. Cl. H01R 13/453; H01R 13/631; H01R 13/635

(52) U.S. Cl. CPC H01R 13/453; H01R 13/631; H01R 13/635

(57) ABSTRACT

A connector includes a housing that includes an engagement member and defines a recess that is configured to receive a retaining structure of a corresponding connector of a device, and a release. When the connector is mated with the corresponding connector of the device, the release is configured to cause movement of the engagement member to displace the retaining structure from the recess.

### CROSS-REFERENCE TO RELATED APPLICATIONS

This application is a National Stage Application of International Patent Application No. PCT/US2022/043565 filed on Sep. 15, 2022, which claims the benefit of U.S. Provisional Application No. 63/244,886, filed on Sep. 16, 2021, the content of which is hereby incorporated by reference herein in its entirety for all purposes.

### FIELD

The present disclosure relates generally to the field of connector assemblies for attaching an accessory to a device.

### BACKGROUND

Some electronic devices are configured so that they can be worn by a user. Examples of such devices include fitness trackers, smart watches, and accessories such as belts and backpacks that incorporate electronic devices or components. Some of these devices may be configured to display visual content to users and/or play audio content to users.

### SUMMARY

A first aspect of the disclosure is a connector. The connector includes a housing that includes an engagement member and defines a recess that is configured to receive a retaining structure of a corresponding connector of a device, and a release. When the connector is mated with the corresponding connector of the device, the release is configured to cause movement of the engagement member to displace the retaining structure from the recess.

A second aspect of the disclosure is an electrical connector. The electrical connector includes a housing that defines a recess that is configured to receive a retaining structure of a corresponding connector of a device. The electrical connector also includes a cover that is configured to obstruct access to the recess and is configured to be displaced by the retaining structure when the electrical connector is mated with the corresponding connector of the device, and a release. When the electrical connector is mated with the corresponding connector of the device, operation of the release causes movement of the cover to displace the retaining structure from the recess.

A third aspect of the disclosure is a system that includes an electrical connector and a receptacle. The electrical connector includes a connector housing that includes an engagement member and defines a recess, a release that is operable to cause movement of the engagement member, and electrical contacts. The receptacle includes a retaining structure that is configured to engage the recess of the electrical connector to prevent removal of the electrical connector from the receptacle when the electrical connector is mated with the receptacle, and electrical contacts that are configured for conductive engagement with the electrical contacts of the electrical connector when the electrical connector is mated with the receptacle. When the electrical connector is mated with the receptacle, operation of the release causes movement of the engagement member to displace the retaining structure from the recess.

A fourth aspect of the disclosure is a connector that includes a housing that defines a recess that is configured to receive a retaining structure of a corresponding connector of a device, a cover that is configured to obstruct access to the recess and is configured to be displaced by the retaining structure when the connector is mated with the corresponding connector of the device, and a release. When the connector is mated with the corresponding connector of the device, operation of the release causes movement of the cover to displace the retaining structure from the recess.

In some implementations of the connector according to the fourth aspect of the disclosure, when the connector is mated with the corresponding connector of the device, the recess is configured to engage the retaining structure of the corresponding connector of the device to prevent removal of the connector from the corresponding connector of the device. In some implementations of the connector according to the fourth aspect of the disclosure, the recess extends transverse to an insertion direction in which the connector is inserted into the corresponding connector of the device. In some implementations of the connector according to the fourth aspect of the disclosure, the housing includes an end surface that is configured to engage the retaining structure of the corresponding connector of the device to allow insertion of the connector into the corresponding connector of the device. In some implementations of the connector according to the fourth aspect of the disclosure, the release is a button. In some implementations of the connector according to the fourth aspect of the disclosure, the connector further includes a release mechanism that is operable to cause movement of the cover in response to operation of the release. In some implementations of the connector according to the fourth aspect of the disclosure, the release mechanism includes a lever that is supported with respect to the housing by a pivot, the lever has a first end that is engageable with the release, and the lever has a second end that is connected to the cover. In some implementations of the connector according to the fourth aspect of the disclosure, the connector further includes electrical contacts that are configured for conductive engagement with the corresponding connector of the device when the connector is mated with the corresponding connector of the device. In some implementations of the connector according to the fourth aspect of the disclosure, the electrical contacts are located on an exterior surface of the housing. In some implementations of the connector according to the fourth aspect of the disclosure, the electrical contacts include conductive pads that are formed on an exterior surface of the housing. In some implementations of the connector according to the fourth aspect of the disclosure, the electrical contacts are located in the recess. In some implementations of the connector according to the fourth aspect of the disclosure, the electrical contacts are located on the cover. The various features of the fourth aspect described in this paragraph can be implemented together or separately, and may further be implemented with the first through third aspects of the disclosure as described above.

### BRIEF DESCRIPTION OF THE DRAWINGS

FIG. 1 is a block diagram of a system that includes a device and an accessory.

FIG. 2 is a perspective illustration that shows a connector assembly in a disconnected position.

FIG. 3 is a perspective illustration that shows the connector assembly in a connected position.

FIGS. 4-9 are illustrations of an electrical connector of the connector assembly that show examples of locations for electrical contacts.

FIGS. 10-13 are cross-section illustrations that show movement of the connector assembly between a connected position and a disconnected position.

FIGS. 14-16 show alternative locations of electrical contacts of the receptacle and the electrical connector.

FIGS. 17-18 show an alternative in which the electrical connector includes a cover in an open end of a recess.

FIGS. 19-22 are cross-section illustrations that show movement of the connector assembly between a connected position and a disconnected position in an alternative that includes a release lever.

FIGS. 23-24 are cross-section illustrations that show an alternative in which the receptacle includes a feedback assembly that applies a feedback force to the electrical connector.

FIG. 25 is an illustration of an alternative in which the electrical connector includes a face gasket for sealing with respect to the receptacle.

FIG. 26 is an illustration of an example implementation of the device and the accessory, in which the device is a wearable electronic device, and the accessory is a part of a support structure for the wearable electronic device.

FIG. 27 is a block diagram that shows an example of a hardware configuration that can be used to implement the device.

### DETAILED DESCRIPTION

The disclosure herein relates to a device with a connector that allows for releasable connection of an accessory to the device. The device is an electronic device, and the connector may include a structural connection of the device to the accessory and an electrical connection of the device to the accessory. In some implementations, the device is a wearable electronic device, and the accessory is part of a support structure that positions the device securely and at a consistent position with respect to a user's body.

The connectors described herein allow secure connection of the accessory to the device, while limiting the visual impact of connector parts by configuring the connector parts in a manner that reduces the visibility of or hides at least some of the connector parts. The connectors described herein are also configured to allow a secure connection and consistent alignment between the device and the accessory.

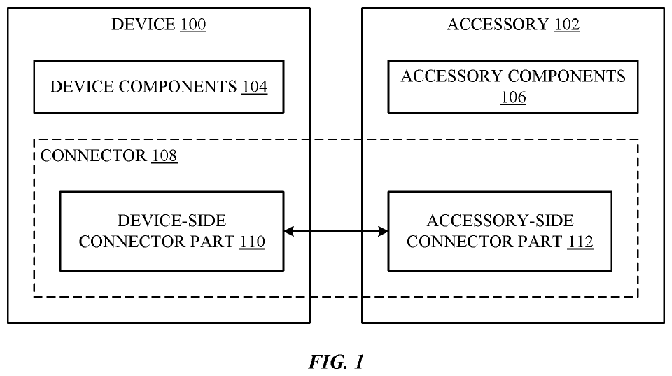

FIG. 1 is a block diagram of a system that includes a device 100 and an accessory 102. The device 100 includes device components 104. The accessory 102 includes accessory components 106. The connector assembly 108 includes a receptacle 110 and an electrical connector 112 that allow the accessory 102 to be removably connected to the device 100.

The device 100 is an electronic device that includes the device components 104. The device components 104 may be or include electrical components that implement functionality of the device 100. As examples, the device components 104 may include a display device, a computing device, input devices, output devices, sensors, a battery, and/or other components. As examples, the device 100 may be a smart watch, a fitness tracker, a near-eye display device such as smart glasses or a computer-generated reality device, or another type of device that includes electronic components that support a particular functionality.

The accessory 102 is an accessory device that is usable with the device 100 in order to enhance the functionality of the device 100. The accessory 102 may include accessory components 106, which are electronic components that are configured to electronically interface with the device components 104 through the connector assembly 108. As examples, the accessory components 106 may include sensors, input components, output components (e.g., audio output components), a battery, and/or other components.

In some implementations, the accessory 102 is a wearable device support structure or a portion of a wearable device support structure. As used herein, a wearable device support structure is a component or collection of components that function to secure the device 100 in place with respect to a user's body so that the device 100 is restrained from moving with respect to user and maintains a comfortable position during use. The wearable device support structure may be in the form of, for example, a band, a strap, a belt, a vest, or headgear. The wearable device support structure may be rigid, may be flexible, or may include one or more rigid portions and one or more flexible portions.

The connector assembly 108 allows the accessory 102 to be connected to and disconnected from the device 100. Connection of the device 100 to the accessory 102 includes a structural connection of the device 100 to the accessory 102 and may include an electrical connection of the device 100 to the accessory 102. The structural connection of the device 100 to the accessory 102 may include securement of the accessory 102 to the device 100 in a manner that resists inadvertent disconnection of the accessory 102 from the device 100, may device define a load-bearing connection between the device 100 and the accessory 102, and may restrain the accessory 102 from moving with respect to the accessory 102. The structural connection of the device 100 to the accessory 102 may be configured to remain connected until a user acts to cause disconnection, such as by operation of a release such as a button, a switch, a slide, or other structure.

Using the connector assembly 108, the accessory 102 may be moved between a connected position and a disconnected position with respect to the device 100. The connected position is a position in which the connector of the accessory 102 is mated with a corresponding connector of the device 100. The disconnected position is a position in which the connector of the accessory 102 is not mated with a corresponding connector of the device 100. As an example, an electrical connector 112 of the accessory 102 may be mated with a receptacle 110 of the device 100 by insertion of the electrical connector 112 into the receptacle 110 of the device 100 and may be unmated from the receptacle 110 of the device 100 may moving the electrical connector 112 out of the receptacle 110. It should be understood that in implementations in which the electrical connector 112 does not include electrical connection components, it may instead be referred to as a connector.

In the connected position, the receptacle 110, which is part of the device 100, is in engagement with the electrical connector 112, which is part of the accessory 102, and the receptacle 110 is restrained from disengagement from the electrical connector 112. In the disconnected position, the receptacle 110 is not restrained from disengagement from the electrical connector 112 and may be moved out of engagement from the electrical connector 112 to a spaced-apart location relative to the electrical connector 112. Further details of the connected position and the disconnected position will be described with respect to specific examples.

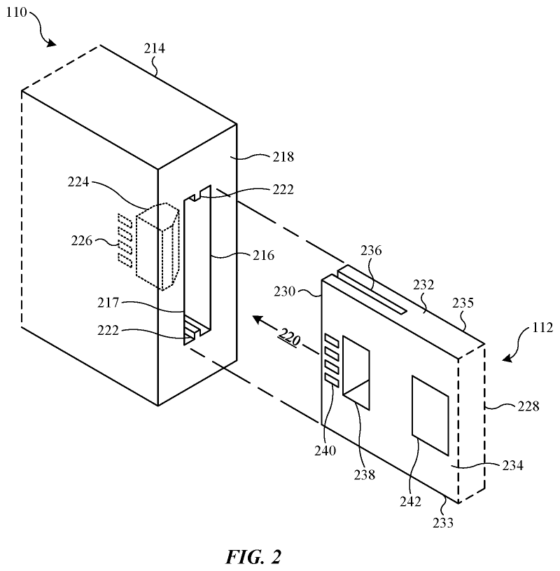

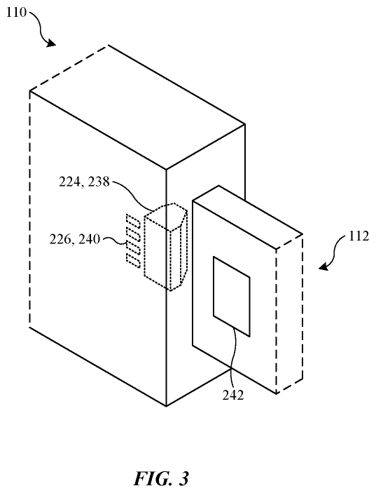

FIG. 2 is an illustration that shows the receptacle 110 and the electrical connector 112 in the disconnected position. FIG. 3 is an illustration that shows the receptacle 110 and the electrical connector 112 in the connected position.

The receptacle 110 includes a housing 214 (which may be referred to as a receptacle housing, a device housing, or a device housing portion), which may be a portion of a device housing of the device 100. A recess 216 (which may be referred to as a device opening, a device recess, or a device housing recess) is defined by the housing 214 and extends inward relative to an open end 217 of the recess 216 that is located at an end surface 218 of the housing 214. The recess 216 is a closed-ended recess having a closed end (not shown in FIG. 2) that is located inward from the open end 217. The direction along which the recess 216 extends (e.g., between the open end 217 and the closed end) is referred to herein as an insertion direction 220 of the electrical connector 112 and corresponds to a line of action along which the electrical connector 112 moves with respect to the receptacle 110 during movement from the connected position to the disconnected position of the connector assembly 108. To align the electrical connector 112 with respect to the receptacle 110 during movement between the connected position and the disconnected position, the receptacle 110 includes alignment features that are formed in the recess 216, such as alignment rails 222. In the illustrated implementation, the alignment rails are protrusions that extend outward from interior surfaces (e.g., top and bottom interior surfaces) of the recess 216.

To establish a structural connection with respect to the electrical connector 112, the receptacle 110 includes a retaining structure, which is a tooth 224 in the illustrated implementation. The tooth 224 is engageable with the electrical connector 112 when the connector assembly 108 is in the engaged position in order to restrain movement of the electrical connector 112 away from the connected position with respect to the receptacle 110. Although the tooth 224 is shown as an example of a retaining structure, the retaining structure may be any manner of projection (e.g., pin, tooth, catch, etc.) that is configured to engage and retain the electrical connector 112.

The tooth 224 is configured to extend into the recess 216 from one of the interior surfaces of the recess 216 to engage the electrical connector 112. To allow the electrical connector 112 to be inserted into and removed from the recess 216, the tooth 224 is movable with respect to the housing 214 between an extended position and a retracted position. Thus, the tooth 224 functions as a retaining structure that is movable with respect to the housing 214 between the extended position and a retracted position, wherein the tooth 224 extends into the recess 216 in the extended position and the tooth 224 is moved at least partly out of the recess 216 in the retracted position to allow the electrical connector 112 to enter and exit the recess 216. The tooth 224 is biased into the recess 216 (e.g., biased by a spring), and is able to move substantially out of the recess 216 during insertion and retraction of the electrical connector 112. For example, the tooth 224 may be engaged by the electrical connector 112 during insertion and thereby deflected from the extended position toward the retracted position. For example, the tooth 224 may be released from engagement with the electrical connector 112 by movement of the tooth 224 from the connected position toward the retracted position to allow movement of the connector assembly 108 from the connected position to the disconnected position. Specific details of the tooth 224 will be described further herein.

To establish an electrical connection with respect to the electrical connector 112, the receptacle 110 includes electrical contacts 226 (which may be referred to as receptacle electrical contacts, device-side electrical contacts, or device electrical contacts). The electrical contacts 226 are electrically conductive structures that are electrically connected to components of the device 100, such as the device components 104, and are configured to facilitate transmission of electrical power, signals, and/or data between the device 100 and the accessory 102. The electrical contacts 226 are located in the recess 216 of the receptacle 110 and extend into the recess 216 from one of the interior surfaces of the recess 216. The electrical contacts 226 may be, for example, pins that are biased outward relative to one of the interior surfaces of the recess 216 and which may be able to move toward the respective interior surface of the recess 216 in response to engagement of a portion of the electrical connector 112 with the electrical contacts 226. In implementations in which the electrical connector 112 is instead a connector that does not establish and electrical connection, the electrical contacts 226 of the receptacle 110 may be omitted.

The electrical connector 112 includes a housing 228 (which may be referred to as a connector housing, an accessory housing, or an accessory housing portion), which may be a portion of an accessory housing of the accessory 102. The geometric configuration of the housing 228 is complementary to the geometric configuration of the recess 216 of the receptacle 110, to allow an end portion of the electrical connector 112 to be moved into the recess 216 of the receptacle 110 in order to move the connector assembly 108 to the connected position. In the illustrated implementation, the housing 228 includes an end surface 230, an upper surface 232, a lower surface 233, a first side surface 234, and a second side surface 235.

The housing 228 includes alignment features that are formed on an exterior surface of the housing 228 to engage the alignment rails 222 or other alignment features of the receptacle 110. In the illustrated implementation, the alignment features of the housing 228 include channels 236 that are formed on the upper surface 232 and the lower surface 233 of the housing 228. The channels 236 extend in alignment with the insertion direction 220 and are configured to receive and engage the alignment rails 222 when the electrical connector 112 is in the recess 216 of the receptacle 110 in order to align the electrical connector 112 with the receptacle 110. Alignment of the electrical connector 112 with the recess 216 of the receptacle 110 is also enforced by engagement of the exterior surfaces of the housing 228 (e.g., including the end surface 230, the upper surface 232, the lower surface 233, and the first side surface 234) with the interior surfaces of the recess 216.

The electrical connector 112 includes a recess 238, which may be referred to as a connector recess, a connector housing recess, an accessory recess, or an accessory housing recess. The recess 238 is formed in the housing 228 and extends transverse to the insertion direction 220, in which the electrical connector 112 is inserted into the corresponding connector of the device 100, such as the receptacle 110.

The recess 238 is configured to receive a retaining structure of a corresponding connector of the device 100. When the electrical connector 112 is mated with the corresponding connector of the device 100, the recess 238 is configured to engage the retaining structure of the corresponding connector of the device to prevent removal of the electrical connector from the corresponding connector of the device. In the illustrated implementation, the tooth 224 of the receptacle 110 of the device 100 functions as a restraining structure and the recess 238 is configured to receive the tooth 224 and be engaged by the tooth 224 in order to establish the structural connection of the receptacle 110 and the electrical connector 112 in the connected position of the connector assembly 108 and to prevent removal of the electrical connector 112 from the receptacle 110. Thus, engagement of the recess 238 with a corresponding connector of the device 100, such as the receptacle 110, prevents removal of the electrical connector 112 from the corresponding connector of the device 100.

The recess 238 is defined by the housing 228 and extends inward relative to on an exterior surface of the housing 228. In the illustrated implementation, the recess 238 is located on the first side surface 234 of the housing 228 and the recess 238 extends inward relative to the first side surface 234 of the housing 228 in a lateral direction that is generally transverse relative to the insertion direction 220. In the connected position, engagement of the tooth 224 of the receptacle 110 with an internal surface of the recess 238 of the electrical connector 112 may restrain the electrical connector 112 from moving out of the recess 216 of the receptacle 110 and thereby moving from the connected position toward the disconnected position.

The electrical connector 112 includes electrical contacts 240 (which may be referred to as connector electrical contacts, accessory-side electrical contacts, or accessory electrical contacts). The electrical contacts 240 are electrically conductive structures that are electrically connected to components of the accessory 102, such as the accessory components 106. The electrical contacts 240 of the electrical connector 112 are configured for conductive engagement with the electrical contacts 226 of the receptacle 110. Thus, the electrical contacts 240 and the electrical contacts 226 and are configured to facilitate transmission of electrical power, signals, and/or data between the device 100 and the accessory 102 by conductive engagement of the electrical contacts 240 of the electrical connector 112 with the electrical contacts 226 of the receptacle 110. In implementations in which the electrical connector 112 is instead a connector that does not establish and electrical connection, the electrical contacts 240 of the electrical connector may be omitted.

The electrical contacts 240 may be located on a surface of the electrical connector 112. The electrical contacts 240 may be electrically conductive pads that are formed on a surface of the electrical connector 112. The electrically conductive pads may be substantially flush relative to the surface of the electrical connector 112 (e.g., the surrounding, adjacent, and/or subjacent surface of the electrical connector 112). As examples, the electrical contacts may be formed on any or all of the end surface 230, the upper surface 232, the lower surface 233, the first side surface 234 and the second side surface 235 of the housing 228 and/or on an interior surface of the recess 238, and/or on a component that is included in the electrical connector 112 and connected to the housing 228.

The electrical connector 112 includes a release 242. The release 242 is a user operable mechanical input component (e.g., release input) that causes disengagement of the tooth 224 of the receptacle 110 from the recess 238 of the electrical connector 112. As examples, the release 242 may be a button, slider, knob, or other user operable component. The release 242 is operable when the connector assembly 108 is in the connected position to allow the connector assembly 108 to move to the disconnected position and thereby allow the electrical connector 112 to be moved out of engagement with the receptacle 110. For example, when the electrical connector 112 is mated with the corresponding connector of the device 100, such as the receptacle 110 of the device 100, the release 242 is configured to cause movement of an engagement member within the recess 238 (e.g., by entering the recess 238 or relocating within the recess 238) to displace a retaining structure of the receptacle 110, such as the tooth 224, from the recess 238. The release 242 may be connected to a release mechanism that is configured to move the tooth 224 out of the recess 238, as will be described herein. Although the release 242 is shown as an externally accessible component that is manipulated manually, the release 242 may instead be actuated using a tool, for example, by insertion of the tool through an aperture defined through and exterior surface of the housing 228 of the electrical connector 112. Although the release 242 is shown as a component that is included in the electrical connector 112, it should be understood that an equivalent mechanism could be included in the receptacle 110 instead.

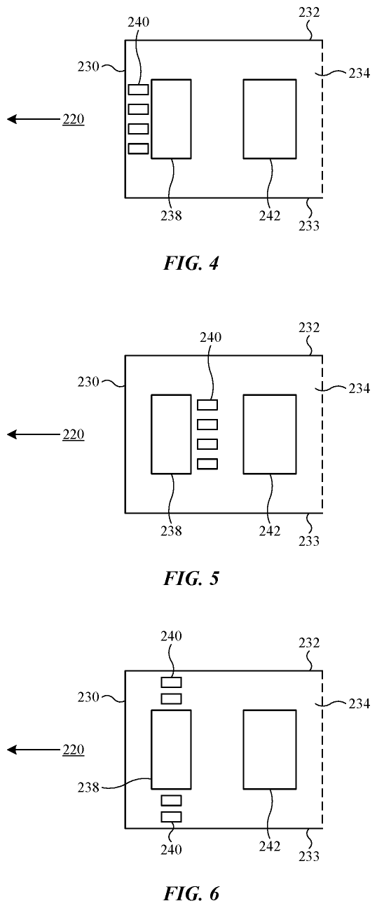

FIGS. 4-9 are schematic illustrations of the electrical connector 112 that show examples of locations for the electrical contacts 240 of the electrical connector 112. It should be understood that locations of electrical contacts 226 of the receptacle 110 are formed in correspondence to the locations of the electrical contacts 240 of the electrical connector 112 to allow electrical engagement of the electrical contacts.

In FIG. 4, the electrical contacts 226 are located on the first side surface 234 of the electrical connector 112 between the recess 238 and the end surface 230 of the housing 228 in the insertion direction 220. In FIG. 5, the electrical contacts 226 are located on the first side surface 234 of the electrical connector 112 rearward of the recess 238 (relative to the insertion direction 220) and located between the recess 238 and the release 242. In FIG. 6, the electrical contacts 226 are located on the first side surface 234 of the electrical connector 112 adjacent to the recess 238 (e.g., upward and downward from) so that a first group of the electrical contacts is positioned between the recess 238 and the upper surface 232 and a second group of the electrical contacts is positioned between the recess 238 and the lower surface 233.

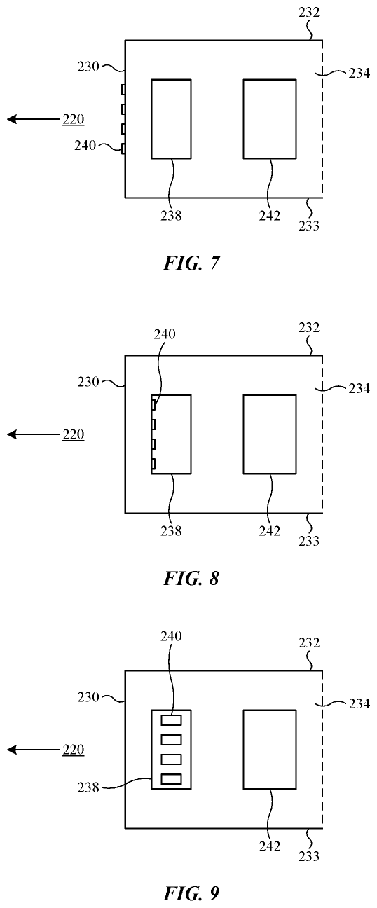

In FIG. 7, the electrical contacts 226 are located on the end surface 230 of the housing 228 and may be conductive pads that are substantially flush with the end surface 230. In FIG. 8, the electrical contacts 226 are located in the recess 238 and are formed on an interior surface of the recess 238 or on a component located inside the recess 238. As illustrated the electrical contacts 226 face rearward (e.g., opposite the insertion direction 220) but can be positioned otherwise in the recess 238, such as located on an internal surface of the recess 238 facing forward (e.g., in the insertion direction 220). In FIG. 9, the electrical contacts 226 are located in the recess 238 and face outward relative to the recess 238. As examples, the electrical contacts may be formed on an internal end surface of the recess 238 or may be formed on a component that is located in the recess 238 or positionable in the recess 238. Although not illustrated in FIGS. 4-9, the electrical contacts 240 may also be located on the upper surface 232, the lower surface 233, or the second side surface 235 of the housing 228.

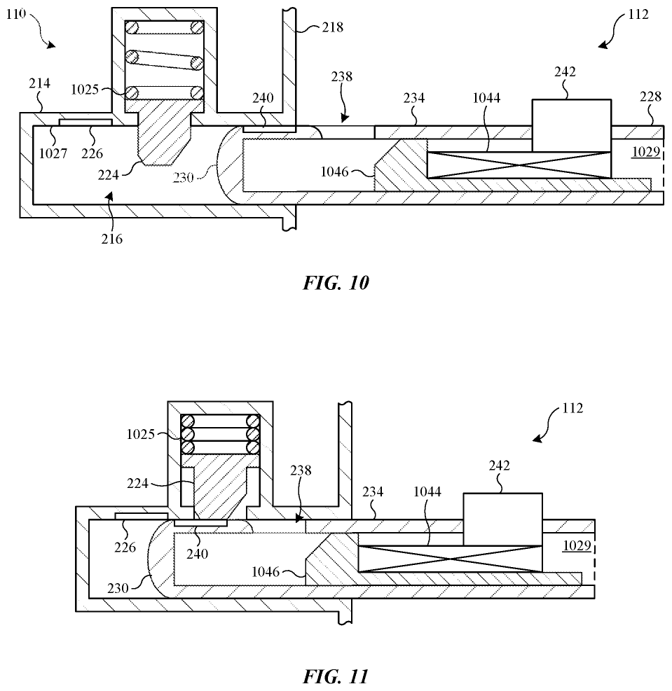

FIGS. 10-13 are cross-section illustrations that show movement of receptacle 110 and the electrical connector 112 between the connected position and the disconnected position. In FIG. 10, the receptacle 110 and the electrical connector 112 are disconnected. The housing 228 of the electrical connector 112 is located partly in the recess 216 of the receptacle 110 so that the electrical connector 112 may be moved toward the connected position, but the electrical connector 112 is not fully inserted into the recess 216. Accordingly, the tooth 224 of the receptacle 110 is in the extended position and is spaced from the recess 238 of the electrical connector 112. Also, the electrical contacts 226 of the receptacle 110 are spaced from the electrical contacts 240 of the electrical connector 112. The tooth 224 extends into the recess 216 to define the extended position as a result of a biasing force applied to the tooth 224 by a spring 1025.

In FIG. 11, the electrical connector 112 and the receptacle 110 remain disconnected, but the electrical connector 112 have been moved further into the recess 216. During movement of the electrical connector 112 into the recess 216, the end surface 230 of the housing 228 engages the tooth 224 and displaces the tooth 224 upward against the biasing forces applied by the spring 1025 until the tooth 224 is displaced out of a path of the electrical connector 112, which may correspond to movement of the tooth 224 out of the recess. Thus, during movement of the electrical connector 112 further into the recess 216 as a part of movement from the disconnected position to the connected position, engagement of the tooth 224 with end surface 230 moves the tooth 224 from the extended position to the retracted position. In this position, the tooth 224 is engaged with the first side surface 234 of the housing 228 between the end surface 230 and the recess 238. Thus, the housing 228 includes the end surface 230, which is configured to engage a retaining structure of the corresponding connector of the device 100, such as the tooth 224 of the receptacle 110 of the device 100, to allow insertion of the electrical connector 112 into the corresponding connector of the device 100.

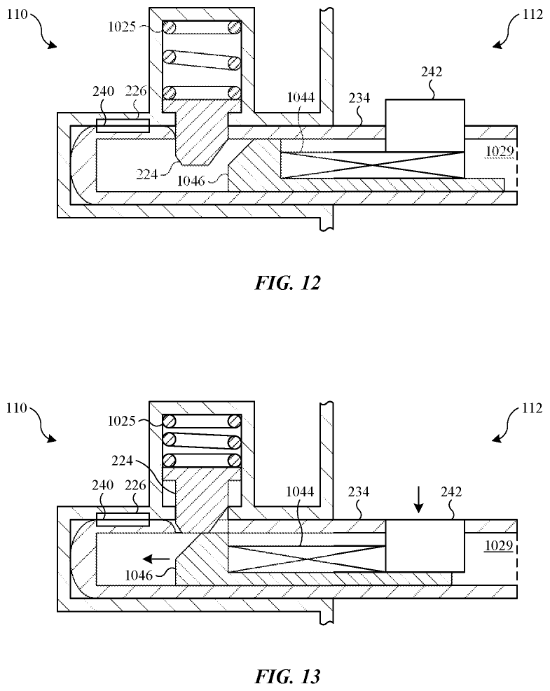

In FIG. 12, the receptacle 110 and the electrical connector 112 have moved to establish the connected position of the connector assembly 108. In particular, continued movement of the electrical connector 112 into the recess 216 aligns the tooth 224 of the receptacle 110 with the recess 238 of the electrical connector 112. Once aligned, the tooth moves into the recess 238 of the electrical connector 112 in response to the biasing force applied to the tooth 224 by the spring 1025. Thus, the tooth 224 moves from the retracted position toward the extended position in response to alignment of the tooth 224 with the recess 238 of the electrical connector 112 during movement from the disconnected position toward the connected position.

While positioned in the recess 238 of the electrical connector 112, the tooth 224 engages the housing 228 of the electrical connector 112 and/or components that are connected to the housing 228 of the electrical connector 112, in order to restrain movement of the electrical connector 112 with respect to the receptacle 110. In the illustrated implementation, the electrical contacts 226 are formed on an internal surface 1027 of the recess 216 and the electrical contacts 240 of the electrical connector 112 are formed on the first side surface 234 of the housing 228 of the electrical connector 112 at a location that corresponds to the location of the electrical contacts 226 in the recess 216, so that the electrical contacts 240 of the electrical connector 112 are brought into engagement (e.g., including conductive electrical communication) with the electrical contacts 226 of the receptacle 110.

To move the connector assembly 108 from the connected position to the disconnected position, the electrical connector 112 includes a release mechanism 1044 that is configured to move an engagement member 1046 into engagement with the tooth 224 in response to operation of the release 242 by the user. The release mechanism 1044 and the engagement member 1046 are located in an internal space 1029 of the housing 228 and are typically not visible from the exterior of the electrical connector 112. Thus, the release mechanism 1044 is located inside the housing 228 of the electrical connector 112 and operatively connects the release 242 to the engagement member 1046 to cause movement of the engagement member 1046 in response to operation of the release 242.

The release mechanism 1044 is a mechanism that is configured to transmit the force applied to the release 242 to the engagement member 1046, such as by causing the engagement member 1046 to translate in a direction that is substantially perpendicular to the direction of displacement of the release 242 as in the illustrated implementation. A number of mechanisms may be used to implement the release mechanism 1044, such as cams, ramps, linkages, levers, sliding connections, fixed connections (e.g., of the release 242 and the engagement member 1046), gears (e.g., a gear train), cables, cords, magnetic components (e.g., magnets, electromagnets, and/or ferromagnetic components that interact with magnets and/or electromagnets). In addition, the movement of the release 242 may be implemented in a manner that causes it to operate other than the illustrated manner of operation, including operation by sliding in the same direction as the induced motion of the engagement member 1046, sliding opposite the direction of the induced motion of the engagement member 1046, sliding transverse relative to the induced motion of the engagement member 1046, or rotating around any axis.

As shown in FIG. 13, the release 242 may be a button that is normally proud relative to the first side surface 234 of the housing 228 and may be operated by depressing it toward the first side surface 234, for example, until it is substantially flush with the first side surface 234. In response to movement of the release 242, the release mechanism 1044 causes a corresponding motion of the engagement member 1046 toward and into engagement with the tooth 224, such as by translation of the engagement member 1046 toward the tooth 224. In the illustrated example, a portion of the engagement member 1046 is configured as a ramp that displaces the tooth 224 out of the recess 238 in response to translation of the engagement member 1046 within the internal space 1029 of the housing 228 in a direction that is substantially transverse to an insertion and removal direction of the tooth 224 with respect to the recess 238. This engagement moves the tooth 224 in a direction that corresponds to retraction of the tooth 224 from the recess 238, and causes the tooth 224 to either completely exit the recess 238 or exit the recess to an extent that allows movement of the electrical connector 112 toward retraction from the recess 216 to further displace the tooth 224 out of the recess 238 of the electrical connector 112 by engagement of the housing 228 of the electrical connector 112 with the tooth 224. Thus, while the tooth 224 is displaced by the engagement member 1046 in response to operation of the release 242, the electrical connector 112 may be moved out of the recess 216 of the receptacle 110 toward the disconnected position of the connector assembly 108.

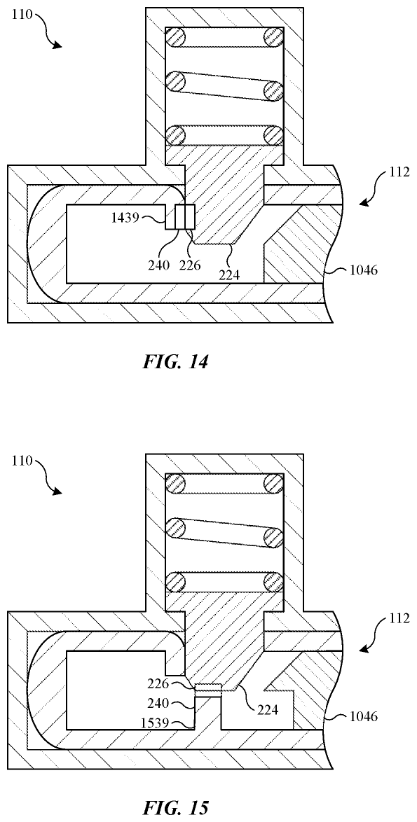

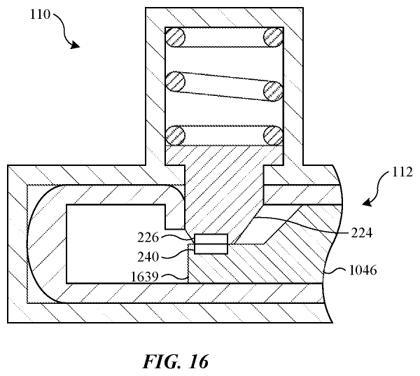

FIGS. 14-16 show alternative location of the electrical contacts 226 of the receptacle 110 and the electrical contacts 240 of the electrical connector 112. In FIG. 14, the electrical contacts 226 of the receptacle 110 are located on a side surface of the tooth 224 and the electrical contacts 240 of the electrical connector 112 are located on an interior side surface 1439 inside the recess 238 of the electrical connector 112. In FIG. 15, the electrical contacts 226 of the receptacle 110 are located on an end surface of the tooth 224 and the electrical contacts 240 of the electrical connector 112 are located on an interior end side surface 1539 inside the recess 238 of the electrical connector 112, and are configured so that the engagement member 1046 slides over them as it translates into engagement with the tooth 224. In FIG. 15, the electrical contacts 226 of the receptacle 110 are located on an end surface of the tooth 224 and the electrical contacts 240 of the electrical connector 112 are located on an extension 1639 that is connected to the engagement member 1046 so that it the electrical contacts 240 are aligned with the tooth 224 and the electrical contacts 226 and slides relative to the tooth as the engagement member 1046 translates to engage and displaces the tooth 224.

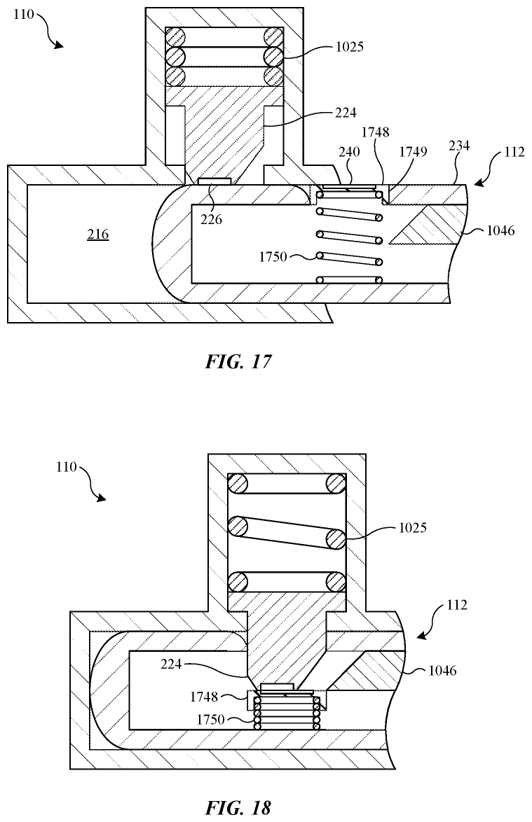

FIGS. 17-18 show an alternative in which the electrical connector 112 includes a cover 1748 is that is located in an open end 1749 of the recess 238 in the disconnected position. As shown in FIG. 17, for example, the cover 1748 may occupy the open end 1749 of the recess 238 in the disconnected position and be positioned so that it is flush relative to the adjacent surface of the housing 228, such as the first side surface 234 of the housing 228 in the illustrated example. As shown in FIG. 18, the cover 1748 is displaced by movement of the tooth 224 into the recess 238 of the electrical connector 112. In the illustrated implementation, the cover 1748 is biased toward location in the open end 1749 of the recess 238 by a spring 1750 and is moved by engagement of the tooth 224 with the cover 1748 so that the tooth overcomes the spring force applied to the cover 1748 by the spring 1750 to move the cover 1748 inward into the housing 228 to establish the connected position. In this implementation, the electrical contacts 226 of the receptacle 110 are located on an end surface of the tooth 224 and the electrical contacts 240 of the electrical connector 112 are located on the outside surface of the cover 1748. Thus, engagement of the tooth 224 with the cover 1748 establishes an electrical connection of the receptacle 110 with respect to the electrical connector 112. It should be understood that the electrical contacts 226 and the electrical contacts 240 may be located otherwise, for example, as described with respect to other implementations. In the illustrated implementation, the engagement member 1046 is configured to engage the tooth 224 above the cover 1748 to move the tooth 224 out of the recess 238 of the electrical connector 112. Alternatively, the engagement member 1046 could be configured to engage the cover 1748 to displace the cover 1748 and the tooth 224 upward together, or the release mechanism 1044 could be configured to move the cover 1748 directly, in which case the engagement member 1046 can be omitted.

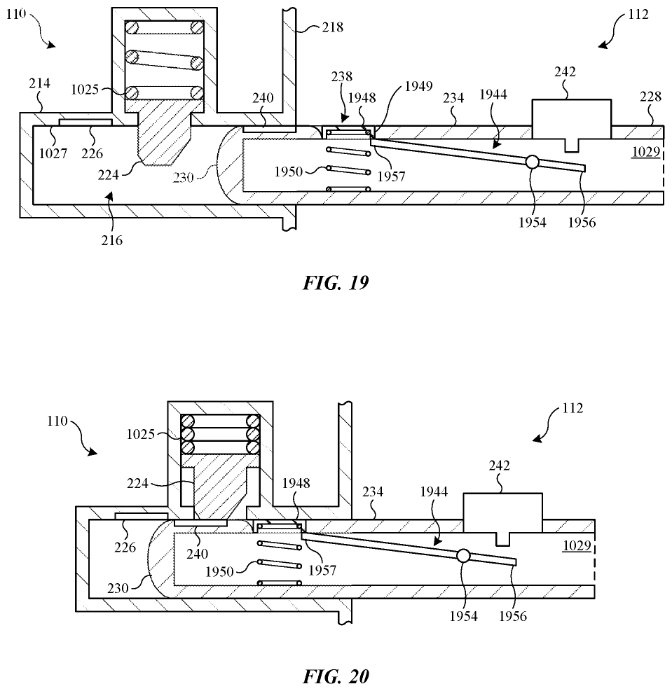

FIGS. 19-22 are cross-section illustrations that show movement of receptacle 110 and the electrical connector 112 between the connected position and the disconnected position according to an alternative implementation that includes a cover 1948 and in which the release mechanism 1044 is replaced by a release lever 1944 that is supported with respect to the housing 228 of the electrical connector 112 by a pivot 1954 (e.g., a pivot joint). The cover 1948 obstructs access to the recess 238 of the electrical connector 112 in the disconnected position and is displaced into the recess 238 by the tooth 224 in the connected position. The cover 1948 is equivalent to the cover 1748 and can be implemented in the same manner. The release lever 1944 is configured to move the cover 1948 and thereby engage and move the tooth 224 outward relative to the recess 238 to disengage the tooth 224 from the housing 228 of the electrical connector 112 and thereby allow the electrical connector 112 and the receptacle 110 to move from the connected position toward the disconnected position. The release lever 1944 has a first end 1956 that is engageable with the release 242 and a second end 1957 that is connected to the cover 1948. The release lever 1944 may be connected to the cover 1948 rigidly, by integral formation, by a pivot joint, by a sliding joint, or in any other suitable manner.

In FIG. 19, the receptacle 110 and the electrical connector 112 are disconnected, and the cover 1948 occupies and obstructs access to an open end 1949 of the recess 238 (e.g., the cover is configured to obstruct the recess 238 in the disconnected position). The first end 1956 of the release lever 1944 is in a lowered position relative to the second end 1957 of the release lever 1944, which is connected to the cover. The first end 1956 of the release lever 1944 is therefore spaced downward from the release lever 1944 as illustrated. The position shown in FIG. 19 is otherwise equivalent to the position described with respect to FIG. 10. In FIG. 20, the cover 1948 and the release lever 1944 have not moved relative to FIG. 19, and the components of the receptacle 110 and the electrical connector 112 are otherwise positioned as described with respect to FIG. 11.

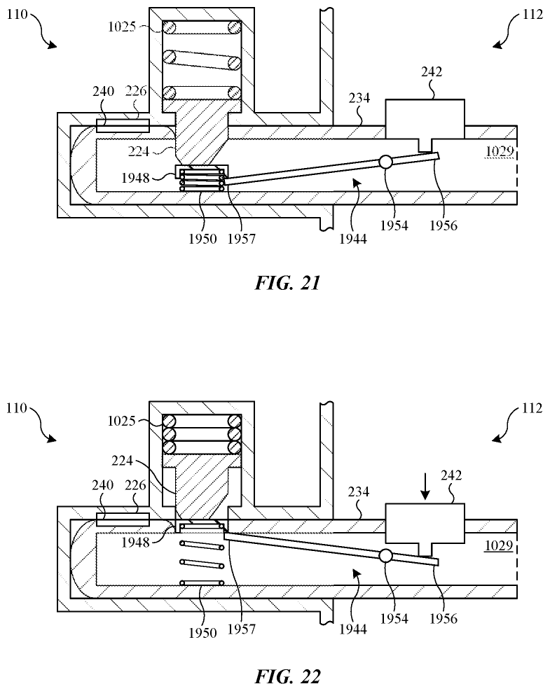

In FIG. 21, alignment of the tooth 224 with the recess 238 of the electrical connector 112 has brought the tooth 224 into engagement with the cover 1948, which displaces the cover 1948 downward into the recess 238 against the biasing force applied by a spring 1950, which is equivalent to the spring 1750. Downward movement of the cover 1948 results in downward movement of the second end 1957 of the release lever 1944 and a corresponding upward movement of the first end 1956. This causes the first end 1956 to move toward the release 242 and may bring the first end 1956 into engagement with the release 242 or an associated component. The position shown in FIG. 21 is otherwise equivalent to the position shown in FIG. 12.

In FIG. 22, the release 242 has been operated by a user. For example, the release 242 may be a button that moves downward when depressed and is biased to return to its original position when released. Movement of the release 242 engages the first end 1956 of the release lever 1944 and moves it (e.g., downward), while connection of the release lever 1944 to the pivot 1954 results in a corresponding opposite (e.g., upward) movement of the second end 1957 of the release lever 1944. The movement of the second end 1957 of the release lever 1944 that is induced by operation of the release 242 causes the cover 1948 to move toward the open end of the recess 238, thereby moving the tooth 224 toward its retracted position and corresponding disengagement from the electrical connector 112. Once the tooth 224 is no longer engaged with the cover 1948, the cover 1948 remains in the open end 1949 of the recess 238 as a result of the biasing force applied to the cover 1948 by the spring 1950. The position shown in FIG. 22 is otherwise equivalent to the position shown in FIG. 13.

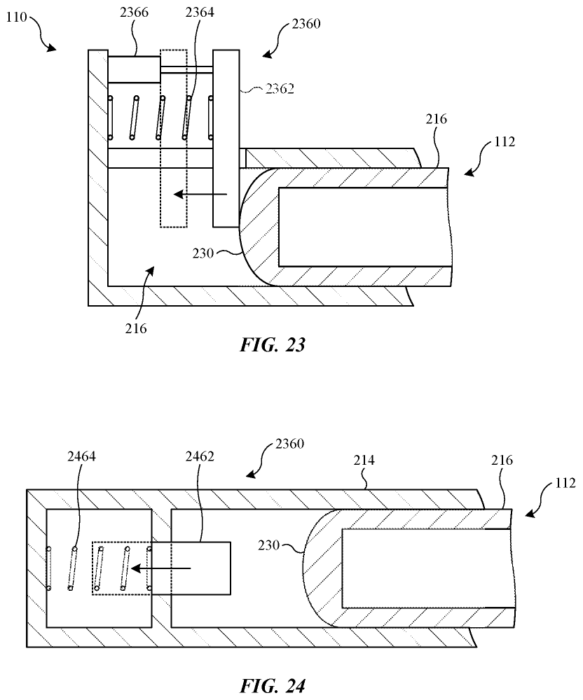

FIGS. 23-24 are cross-section illustrations that show an alternative in which the receptacle 110 includes a feedback assembly 2360 that applies a feedback force to the electrical connector 112. In FIG. 23, the feedback assembly 2360 includes a feedback structure in the form of a projection 2362 that extends into the recess 216 through an internal side surface of the recess 216. The projection 2362 is movable in the insertion direction and opposite the insertion direction. The projection 2362 is biased opposite the insertion direction by a biasing element such as a spring 2364. The biasing force applied by the spring 2364 resists insertion of the electrical connector 112 to provide a better feedback sensation to the user when moving the electrical connector 112 toward the connected position. During movement toward the disconnected position, the biasing force applied by the spring 2364 to the projection 2362 and the electrical connector 112 urges the electrical connector 112 out of the recess 216. The outward motion of the projection 2362 may be damped by a damper 2366 to control the rate at which the electrical connector 112 is urged outward. In FIG. 24, the feedback assembly 2360 includes a feedback structure in the form of a pin 2462 that extends into the recess 216 through an internal end surface of the recess 216 and is biased opposite the insertion direction by a spring 2464. Operation of the pin 2462 and the spring 2464 is equivalent to operation of the projection 2362 and the spring 2364. Accordingly, the receptacle 110 may include a feedback structure that is located in the recess 216 and is configured to apply a biasing force to the electrical connector 112 to resist movement of the electrical connector 112 into the recess 216.

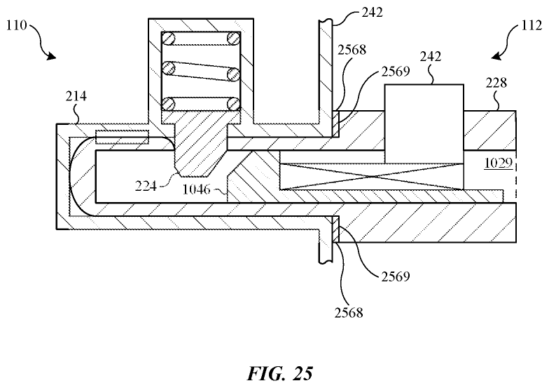

FIG. 25 is a cross-section illustration of an alternative in which the electrical connector 112 includes a face gasket 2568 for sealing with respect to the receptacle 110. In particular, the housing 228 of the electrical connector 112 includes a stepped portion 2569 at which the housing 228 widens and defines a face that is oriented toward the end surface 218 of the housing 214 in the connected position, as shown in FIG. 25. The stepped portion is located between the recess 238 and the release 242 so that the recess 238 is allowed to enter the receptacle 110 during insertion. The face gasket 2568 is located adjacent to the face of the stepped portion 2569 and may be connected (e.g., by an adhesive) to the housing 228 of the electrical connector. Thus, connection of the electrical connector 112 with the receptacle positions the face gasket 2568 between the end surface 2218 of the housing 218 and the steeped portion 2569 of the housing 228, thereby defining a seal between the receptacle 110 and the electrical connector 112 to resist entry of contaminants, such as liquids. Other features are as previously described. The configuration shown in FIG. 5 may be used in conjunction with any of the other implementations described herein.

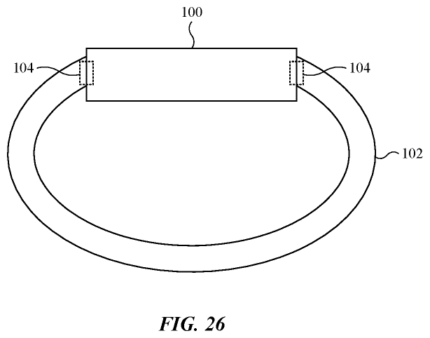

FIG. 26 is an illustration of an example implementation of the device 100 and the accessory 102, in which the device 100 is a wearable electronic device and the accessory 102 is a part of a support structure for the wearable electronic device that allows the wearable electronic device to be worn by a user, for example, by securing the wearable electronic device at a consistent position so that it does not move. In the illustrated implementation, the accessory 102 is shown as single unit that is connected to the device 100 by two instances of the connector assembly 108. It should be understood, however, that other configurations are possible, such as a single instance of the connector assembly 108 or three or more connectors. As an example, the support structure for the wearable electronic device may include components other than the accessory 102. As an example, the support structure may include two or more instances of the accessory 102 (which may be the same as each other or different from each other).

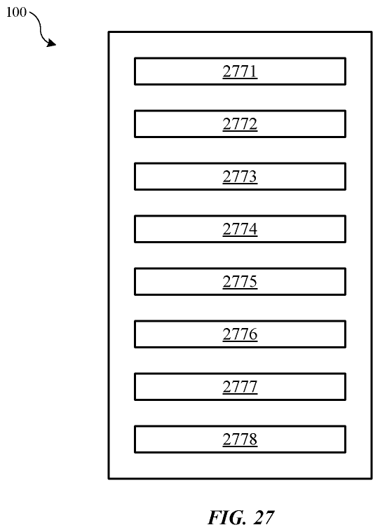

FIG. 27 is a block diagram that shows an example of a hardware configuration that can be used to implement the device 100. In the illustrated example, the electronic device includes a processor 2771, a memory 2772, a storage device 2773, a communications device 2774, sensors 2775, a power source 2776, a display device 2777, and an optical system 2778. Some of the devices shown as included in the device 100 may be included in the accessory 102 as part of the accessory components

The processor 2771 is a device that is operable to execute computer program instructions and is operable to perform operations that are described by the computer program instructions. The processor 2771 may be implemented using one or more conventional devices and/or more or more special-purpose devices. As examples, the processor 2771 may be implemented using one or more central processing units, one or more graphics processing units, one or more application specific integrated circuits, and/or one or more field programmable gate arrays. The processor 2771 may be provided with computer-executable instructions that cause the processor 2771 to perform specific functions. The memory 2772 may be one or more volatile, high-speed, short-term information storage devices such as random-access memory modules.

The storage device 2773 is intended to allow for long term storage of computer program instructions and other data. Examples of suitable devices for use as the storage device 2773 include non-volatile information storage devices of various types, such as a flash memory module, a hard drive, or a solid-state drive.

The communications device 2774 supports wired or wireless communications with other devices. Any suitable wired or wireless communications protocol may be used.

The sensors 2775 are components that are incorporated in the device 100 to generate sensor output signals that are used as inputs by the processor 2771 for use in generating content, as will be described herein. The sensors 2775 may include components that facilitate motion tracking. The sensors 2775 may also include additional sensors that are used by the device to generate and/or enhance the user's experience in any way. The sensors 2775 may include conventional components such as cameras, infrared cameras, infrared emitters, depth cameras, structured-light sensing devices, accelerometers, gyroscopes, and magnetometers. The sensors 2775 may also include biometric sensors that are operable to physical or physiological features of a person, for example, for use in user identification and authorization. Biometric sensors may include fingerprint scanners, retinal scanners, and face scanners (e.g., two-dimensional and three-dimensional scanning components operable to obtain image and/or three-dimensional surface representations). Other types of devices can be incorporated in the sensors 2775. The information that is generated by the sensors 2775 is provided to other components of the electronic device, such as the processor 2771, as inputs.

The power source 2776 supplies electrical power to components of the device 100. In some implementations, the power source 2776 is a wired connection to electrical power. In some implementations, the power source 2776 may include a battery of any suitable type, such as a rechargeable battery. In implementations that include a battery, the device may include components that facilitate wired or wireless recharging. The power source 2776 may be located in the accessory 102 as part of the accessory components 106 and transfer electrical power to the device 100 using the connector assembly 108.

The display device 2777 functions to display content to the user in the form of emitted light that is output by the display device 2777 and is directed toward the user's eyes by the optical system 2778. The display device 2777 is a light-emitting display device, such as a video display of any suitable type, that is able to output images in response to a signal that is received from the processor 2771. The display device 2777 may be of the type that selectively illuminates individual display elements according to a color and intensity in accordance with pixel values from an image. As examples, the display device may be implemented using a liquid-crystal display (LCD) device, a light-emitting diode (LED) display device, a liquid crystal on silicon (LCoS) display device, an organic light-emitting diode (OLED) display device, or any other suitable type of display device. The display device 2777 may include multiple individual display devices.

The optical system 2778 can be utilized in the device 100 to output content to the user. As examples, the optical system 2778 may include lenses, reflectors, polarizers, filters, optical combiners, and/or other optical components. In some implementations of the device 100, the optical system 2778 is omitted. For example, in implementations in which the electronic device is a smart watch that is configured to be worn on the user's wrist, the optical system 2778 may be omitted.

In the description, terms such as “up,” “down,” “left,” “right,” “forward,” and “rearward,” are used for convenience and explanatory purposes to aid in understanding of the subject matter. It should be understood that described components are not necessarily limited to such positions or directions of movement.

As described above, one aspect of the present technology is operation of an electronic device, which may include the gathering and use of data available from various sources for use by the electronic device. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores information that allows operation of the electronic device to be customized according to the preferences of a user. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for customization of operation of an electronic device, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, customizations may be made to operation of the electronic device by the user each time the electronic device is used, and without subsequently storing the information or associating the information with the particular user.

1. A connector, comprising:
a housing that defines a recess that is configured to receive a retaining structure of a corresponding connector of a device;
a cover that is configured to obstruct access to the recess and is configured to be displaced by the retaining structure when the connector is mated with the corresponding connector of the device; and
a release, wherein, when the connector is mated with the corresponding connector of the device, operation of the release causes movement of the cover to displace the retaining structure from the recess.

2. The connector of claim 1, wherein, when the connector is mated with the corresponding connector of the device, the recess is configured to engage the retaining structure of the corresponding connector of the device to prevent removal of the connector from the corresponding connector of the device.

3. The connector of claim 1, wherein the recess extends transverse to an insertion direction in which the connector is inserted into the corresponding connector of the device.

4. The connector of claim 1, wherein the housing includes an end surface that is configured to engage the retaining structure of the corresponding connector of the device to allow insertion of the connector into the corresponding connector of the device.

5. The connector of claim 1, wherein the release is a button.

6. The connector of claim 1, further comprising:
a release mechanism that is operable to cause movement of the cover in response to operation of the release.

7. The connector of claim 6, wherein the release mechanism includes a lever that is supported with respect to the housing by a pivot, the lever has a first end that is engageable with the release, and the lever has a second end that is connected to the cover.

8. The connector of any of claim 1, further comprising:
electrical contacts that are configured for conductive engagement with the corresponding connector of the device when the connector is mated with the corresponding connector of the device.

9. The connector of claim 8, wherein the electrical contacts are located on an exterior surface of the housing.

10. The connector of claim 8, wherein the electrical contacts include conductive pads that are formed on an exterior surface of the housing.

11. The connector of claim 8, wherein the electrical contacts are located in the recess.

12. The connector of claim 8, further wherein the electrical contacts are located on the cover.

13-15. (canceled)

16. A connector, comprising:
a housing that includes an engagement member and defines a recess that is configured to receive a retaining structure of a corresponding connector of a device;
electrical contacts that are configured for conductive engagement with the corresponding connector of the device when the connector is mated with the corresponding connector of the device; and
a release,
wherein, when the connector is mated with the corresponding connector of the device, the recess is configured to engage the retaining structure of the corresponding connector of the device to prevent removal of the connector from the corresponding connector of the device, and
wherein, when the connector is mated with the corresponding connector of the device, the release is configured to cause movement of the engagement member to displace the retaining structure from the recess.

17. The connector of claim 16, wherein the recess extends transverse to an insertion direction in which the connector is inserted into the corresponding connector of the device.

18. The connector of claim 16, wherein the housing includes an end surface that is configured to engage the retaining structure of the corresponding connector of the device to allow insertion of the connector into the corresponding connector of the device.

19. The connector of claim 16, wherein the electrical contacts are located on an exterior surface of the housing.

20. The connector of claim 16, wherein the electrical contacts are located in the recess.

21. A system, comprising:
an electrical connector having:
a connector housing that includes an engagement member and defines a recess,
a release that is operable to cause movement of the engagement member, and
electrical contacts; and
a receptacle having:
a retaining structure that is configured to engage the recess of the electrical connector to prevent removal of the electrical connector from the receptacle when the electrical connector is mated with the receptacle, and
electrical contacts that are configured for conductive engagement with the electrical contacts of the electrical connector when the electrical connector is mated with the receptacle,
wherein, when the electrical connector is mated with the receptacle, operation of the release causes movement of the engagement member to displace the retaining structure from the recess.

22. The system of claim 21, wherein:
the connector housing includes an end surface, and engagement of the end surface of the connector housing with the retaining structure of the receptacle moves the retaining structure from an extended position to a retracted position to allow insertion of the electrical connector into the receptacle,
the retaining structure is biased toward the extended position, and
the retaining structure moves from the retracted position toward the extended position in response to alignment of the retaining structure with the recess of the electrical connector during insertion of the electrical connector into the receptacle.

23. The system of claim 21, wherein the electrical connector includes a cover that is configured to obstruct the recess and is displaced by the retaining structure when the electrical connector is mated with the receptacle.
